(19) United States
(12) Patent Application Publication
(10) Pub. No.: US 2013/0091038 A1
(43) Pub. Date: Apr. 11, 2013

(54) ASSOCIATING ELECTRONIC COMMERCE LISTINGS WITH CONTENT

(71) Applicant: Neelakantan Sundaresan, Mountain View, CA (US)

(72) Inventor: Neelakantan Sundaresan, Mountain View, CA (US)

(21) Appl. No.: 13/271,003

(22) Filed: Oct. 11, 2011

(51) Int. Cl. G06Q 30/06

(52) U.S. Cl. 705/27.1

(57) ABSTRACT

A method and system associate electronic commerce listings with online content. In some embodiments, the a content provider presents content to a user. A request is received from the user to associate an electronic commerce listing of the user with the content. If the request is approved, an indicator is displayed within the content and associated with the electronic commerce listing.

### TECHNICAL FIELD

The present disclosure generally relates to network communications and, more specifically, to systems and methods for associating electronic commerce listings with content.

### BACKGROUND

Advancements in computer and networking technology enable users and entities to conduct various types of online activities via computer-based applications and systems. These online activities may include offering items for purchase through listings in, for example, a network-based marketplace. Presenting these listings to users having potential interest in the items contained in the listings increases the likelihood that a user will purchase an item.

### BRIEF DESCRIPTION OF THE DRAWINGS

Some embodiments are illustrated by way of example and not limitation in the figures of the accompanying drawings.

FIG. 1 is a block diagram of a client-server system within which an example embodiment may be deployed.

FIG. 2 is a block diagram of a content provider manager, in accordance with some embodiments of the present invention.

FIG. 3 is a block diagram of a listing manager, in accordance with some embodiments of the present invention.

FIG. 4 is a flow diagram of a method, in accordance with an embodiment, of registering a content provider with a network-based marketplace.

FIG. 5 is a flow diagram of a method, in accordance with an embodiment, of associating an electronic commerce listing with content presented by a content provider.

FIG. 6 is a flow diagram of a method; in accordance with an embodiment, of completing a transaction with a network-based marketplace initiated by a user accessing content presented by a content provider.

FIG. 7 depicts, in accordance with an embodiment, a portion of a user interface for displaying content and an indicator associated with an electronic commerce listing.

FIG. 8 depicts, in accordance with an embodiment, a table containing user data associated with a user's electronic commerce transactions.

FIG. 9 is a block diagram of a machine in the example form of a computer system within which a set of instructions, for causing the machine to perform any one or more of the methodologies discussed herein, may be executed.

### DETAILED DESCRIPTION

Example systems and methods to associate electronic commerce listings with content presented by a content provider are described. In the following description, for purposes of explanation, numerous specific details are set forth in order to provide a thorough understanding of example embodiments. It will be evident, however, to one skilled in the art that the present invention may be practiced without these specific details.

As used herein, a “user” or an “entity” may be a person (e.g., a human), a business (e.g., a company), an organization, a group of people, a persona (e.g., a fictitious character), a bot (e.g., an automated program that performs particular functions), or any combination thereof. Although particular examples discussed herein refer to “products”, the teachings of the described systems and methods are applicable to any type of electronic commerce listing for any product, service, item, and the like.

As used herein, “electronic commerce” includes any process or activity associated with the buying or selling of items using electronic systems. Further, an “electronic commerce site” includes any web site, computer network or other systems that support or facilitate electronic commerce. Although particular examples discussed herein refer to “network-based marketplaces”, the described systems and methods are applicable to any type of electronic commerce site. Further, as used herein, an “electronic commerce listing” includes any purchase or sale listing associated with any electronic commerce site. Although particular examples discussed herein refer to “marketplace listings”, the described systems and methods are applicable to any type of electronic commerce listing.

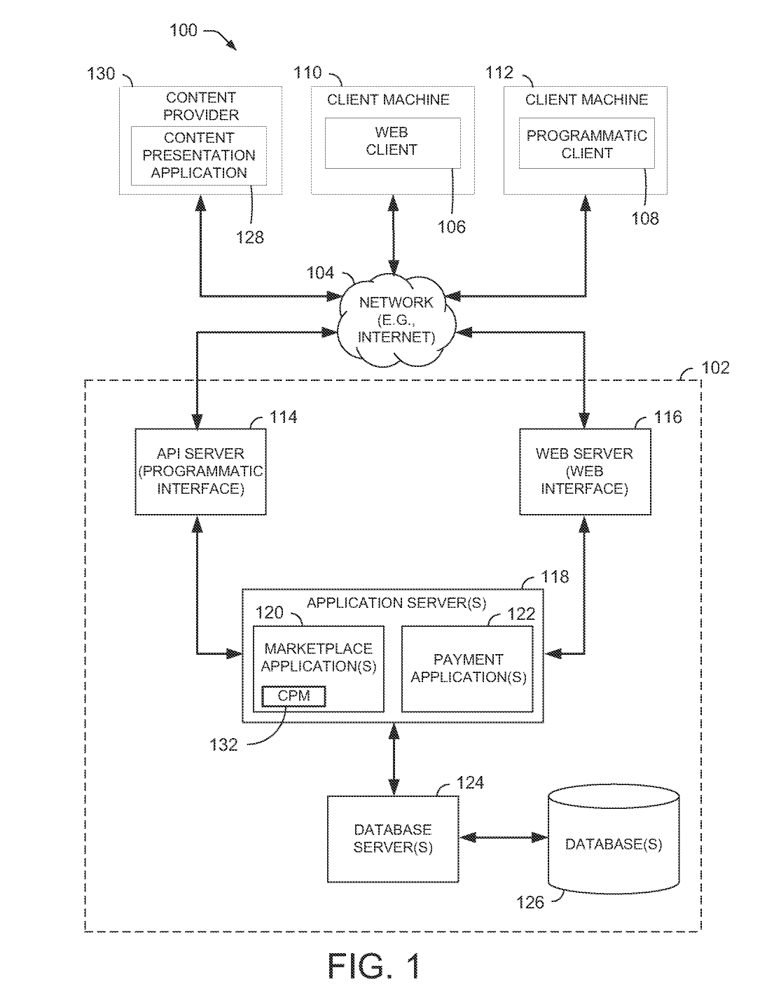

FIG. 1 is a block diagram of a client-server system 100 within which an example embodiment may be deployed. A networked system 102, in the example forms of a network-based marketplace or publication system, provides server-side functionality via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash.), and a programmatic client 108 executing on respective client machines 110 and 112.

An Application Programming Interface (API) server 114 and a web server 116 are coupled to, and provide programmatic and web interfaces respectively to, one or more application servers 118. Application servers 118 host one or more marketplace applications 120 and payment applications 122. Application servers 118 are, in turn, shown to be coupled to one or more database servers 124 that facilitate access to one or more databases 126.

Marketplace applications 120 may provide a number of marketplace functions and services to users that access networked system 102. Payment applications 122 may likewise provide a number of payment services and functions to users. Payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of networked system 102, it will be appreciated that, in alternative embodiments, payment applications 122 may form part of a payment service that is separate and distinct from networked system 102.

Further, while the system 100 shown in FIG. 1 employs a client-server architecture, the present invention is not limited to such an architecture, and could equally well find application in a distributed, or peer-to-peer, architecture system, for example. The various marketplace and payment applications 120 and 122 could also be implemented as standalone software programs, which do not necessarily have networking capabilities.

Web client 106 accesses the various marketplace and payment applications 120 and 122 via the web interface supported by web server 116. Similarly, programmatic client 108 accesses the various services and functions provided by the marketplace and payment applications 120 and 122 via the programmatic interface provided by API server 114. Programmatic client 108 may, for example, be a seller application (e.g., the TurboLister application developed eBay Inc., of San Jose, Calif.) to enable sellers to author and manage listings on networked system 102 in an off-line manner, and to perform batch-mode communications between programmatic client 108 and networked system 102. Some embodiments of present invention may be implemented by components of the marketplace application(s) 120. For example, a content provider manager 132 or other system performs the marketplace listing management functions and activities described herein.

FIG. 1 also illustrates a third party content presentation application 128, executing on a third party content provider server machine 130, as having programmatic access to networked system 102 via the programmatic interface provided by API server 114. For example, third party content presentation application 128 may, utilizing information retrieved from networked system 102, support one or more features or functions on a website hosted by the third party content provider. The third party content provider website may, for example, present content that includes one or more indicators associated with one or more marketplace listings maintained within networked system 102.

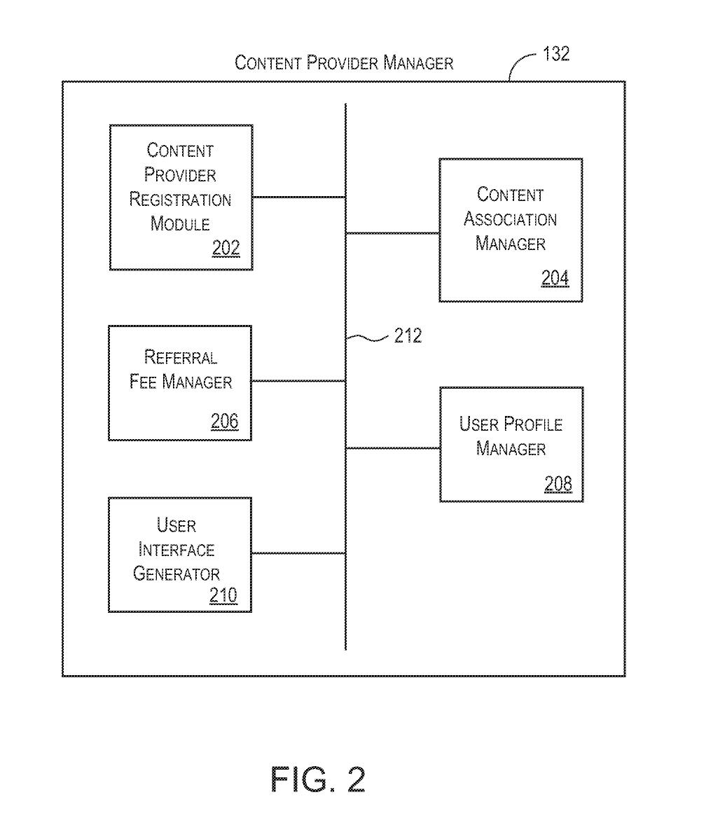

FIG. 2 is a block diagram of a content provider manager 132, in accordance with some embodiments of the present invention. Content provider manager 132 may be executed or included in, for example, an application server 118 implements computer programs, logic, applications, methods, processes, or software to manage associations between marketplace listings and third party content providers.

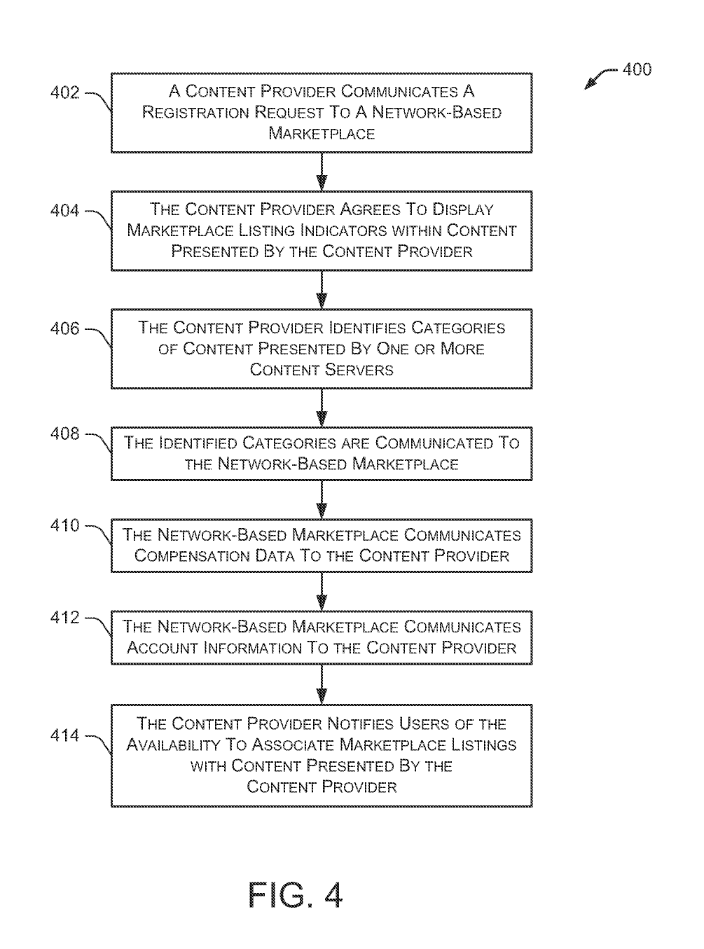

In the embodiment of FIG. 2, content provider manager 132 includes a content provider registration module 202 that manages registration of multiple content providers with the network-based marketplace supported by networked system 102. The registration process is further described herein with reference to FIG. 4. Content provider manager 132 also includes a content association manager 204 that establishes and maintains associations between marketplace listings and third party content providers. Additionally, content provider manager 132 can maintain information regarding types of content presented by various third party content providers.

Content provider manager 132 further includes a referral fee manager 206 that tracks completed marketplace transactions referred by (or initiated by) specific third party content providers. In some embodiments, a third party content provider receives compensation (e.g., a referral fee) for marketplace transactions initiated by user interaction with content presented by the third party content provider. A user profile manager 208 maintains and manages data associated with multiple user profiles. For example, user profile manager 208 may create, store, and update user profile data.

A user interface generator 210 creates a user interface to display various marketplace listing information (e.g., one or more marketplace listings related to content presented by a third party content provider) to a user. A communication bus 212 is coupled to the various modules and components in content provider manager 132, thereby allowing the modules and components to communicate with one another. Communication bus 212 may use any communication protocol and any communication media.

In alternate embodiments, content provider manager 132 may include fewer or more modules apart from those shown in FIG. 2. For example, in one alternate embodiment, content provider registration module 202 is integrated within content association manager 204. Content provider registration module 202, content association manager 204, referral fee manager 206, user profile manager 208, and user interface generator 210 truly be in the form of software that is processed by a processor. In another example, as described herein, modules 202, 204, 206, 208, 210, and 212 may be in the form of firmware that is processed by application specific integrated circuits (ASICs), which may be integrated into a circuit board. Alternatively, modules 202, 204, 206, 208, 210, and 212 may be in the form of one or more logic blocks included in a programmable logic device (e.g., a field programmable gate array (FPGA)). The described modules 202, 204, 206, 208, 210, and 212 may be adapted, and/or additional structures may be used to provide alternative or additional functionalities beyond those specifically discussed with reference to FIG. 2.

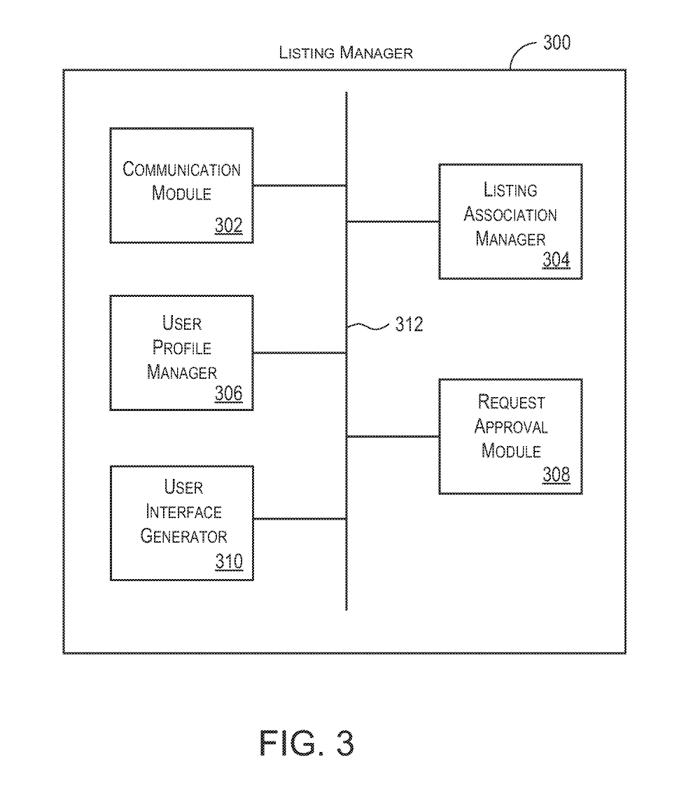

FIG. 3 is a block diagram of a listing manager 300, in accordance with some embodiments of the present invention. In various embodiments, listing manager 300 implements computer programs, logic, applications, methods, processes, or software to manage associations between displayed content and electronic commerce listings. In the embodiment of FIG. 3, listing manager 300 includes a communication module 302 that communicates with other systems and components to implement the functions described herein. A listing association manager 304 handles the generation and management of associations between content and various electronic commerce listings.

Listing manager 300 also includes a user profile manager 306 that maintains and manages data associated with multiple user profiles. For example, user profile manager 306 may create, store, and update user profile data. A request approval module 308 approves requests from users to associate a listing with specific content. A user interface generator 310 creates a user interface to display various content, listing information, and other information to any number of users. A communication bus 312 is coupled to the various modules and components in listing manager 300, thereby allowing the modules and components to communicate with one another. Communication bus 312 may use any communication protocol and any communication media.

FIG. 4 is a flow diagram of a method 400, in accordance with an embodiment, of registering a content provider with a network-based marketplace. In a particular embodiment, at least a portion of method 400 is implemented by a processor or computing system, such as one or more of the processors and computing systems discussed herein. Initially, a content provider communicates a registration request to a network-based marketplace at 402. The network-based marketplace may include any number of marketplace listings. Each marketplace listing is associated with one or more items offered for sale by a user or entity.

When registering with the network-based marketplace, the content provider agrees to display one or more marketplace listing indicators within content presented by the content provider at 404. As discussed in greater detail below, a user or entity associated with a marketplace listing may desire to place an indicator within the content presented by the content provider. The indicator is associated with (or linked to) the marketplace listing of the user or entity. A viewer of the content containing the indicator may activate the indicator to receive details regarding the marketplace listing. In particular embodiments, the marketplace listing associated with the indicator is related to the topic of the content presented by the content provider.

Method 400 continues at 406 as the content provider identifies one or more categories of content presented by one or more content servers. A particular content provider may use any number of content servers to present content to any number of users. The identified content categories are communicated to the network-based marketplace at 408. The network-based marketplace may use these content categories to identify marketplace listings that are appropriate for a particular content provider. Additionally, the network-based marketplace may use the content categories to verify that a user request to display a marketplace listing indicator within particular content is appropriate based on the content categories.

Next, the network-based marketplace communicates compensation data to the content provider at 410. By registering with the network-based marketplace, the content provider is eligible to receive a referral fee based on users that complete a marketplace transaction in response to activating a marketplace listing indicator displayed by the content provider. This payment may also be referred to as a “commission”, “affiliate commission”, “affiliate payment” or other terms describing a form of compensation. The compensation data communicated to the content provider includes payment amounts, payment methods, payment frequency, and other terms related to the payment of compensation from the network-based marketplace to the content provider.

Method 400 continues as the network-based marketplace communicates account information to the content provider at 412. The account information includes, for example, a unique account number (or identifier) associated with the content provider, account login name, account login password, and the like. Additionally, the account information may include user feedback, items bought or sold by a user, user participation in product reviews, user interests, and information accessed from other services or web sites for which the user has granted access permission. In some embodiments, the account information also includes URLs (Uniform Resource Locators) or instructions for associating marketplace listings with indicators placed within the content presented by the content provider.

In some embodiments, the content provider notifies users of the availability to associate marketplace listings with content presented by the content provider at 414. For example, the content provider may include a notice to viewers of content that they have the option to add an indicator to the content that is associated with a marketplace listing for an item that is relevant to the displayed content. In another example, the content provider maintains a list of users who access content through one or more content servers. These users are notified of the ability to associate a marketplace listing with content presented by the content provider.

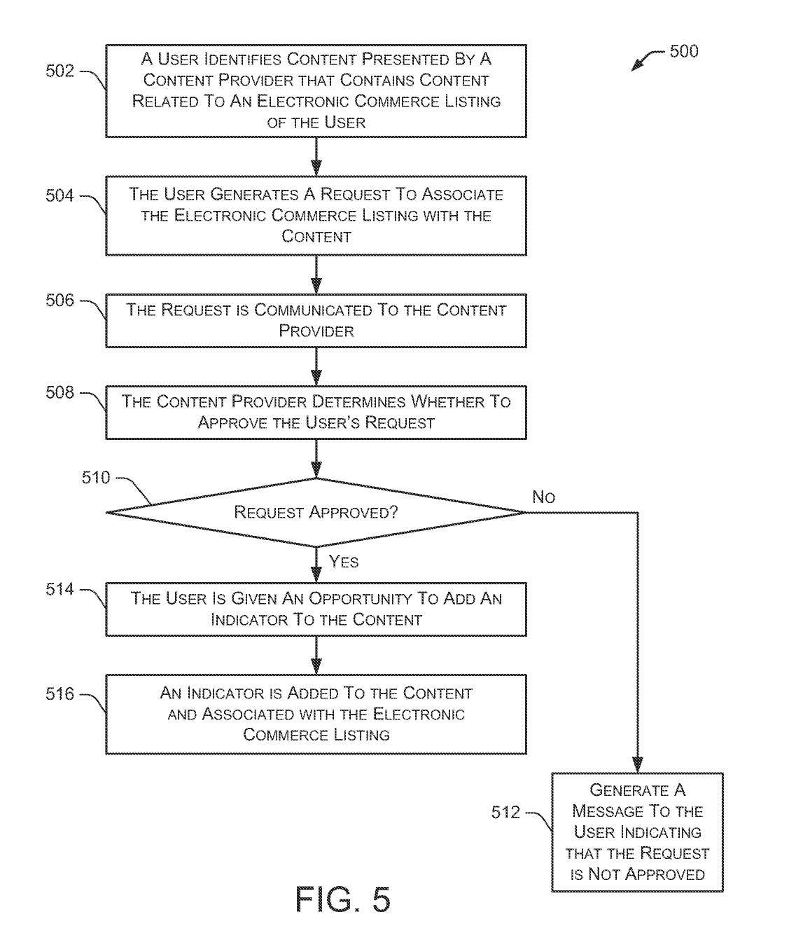

FIG. 5 is a flow diagram of a method 500, in accordance with an embodiment, of associating an electronic commerce listing with content presented by a content provider. In a particular embodiment, at least a portion of method 500 is implemented by a processor or computing system, such as one or more of the processors and computing systems discussed herein. Initially, a user identifies content presented by a content provider that contains content related to an electronic commerce listing of the user at 502. The content includes any type of content from any source. For example, the content may include news articles, product reviews; social media posts, and the like. A particular content provider may present any number of different types of content through any number of different content servers or other data sources.

The user generates a request to associate the electronic commerce listing with the content at 504. The user may generate this request, for example, because the user believes that a viewer interested in the content is also likely to be interested in the item that is the subject of the electronic commerce listing.

The request from the user is communicated to the content provider at 506. Upon receiving the request, the content provider determines whether to approve the user's request at 508. The decision by the content provider may include, for example, determining whether the content provider believes the electronic commerce listing is relevant to the content. Additionally, the content provider may consider how many other electronic commerce listings are already associated with the same content and how many other electronic commerce listing associations have resulted in completed transactions by users viewing similar content. In some embodiments, the content provider considers the price of the item in the electronic commerce listing or identify categories of items that should be associated with the content. The content provider may also use information about viewers who typically access the content to determine what types of electronic commerce listings are of most interest to (or most appropriate for) those viewers. Additionally, the content provider may designate certain categories of listings that can be associated with specific content. For example, content related to automobiles may be restricted to electronic commerce listings associated with automobiles or automobile products/services.

If the request is not approved at 510, the content provider generates a message to the user indicating that the request was not approved at 512. The message may also indicate one or more reasons why the request was not approved. If the request is approved at 510, the user is given an opportunity to add an indicator to the content at 514. As discussed herein, the indicator may be a visual indicator that identifies one or more electronic commerce listings related to the content. In some embodiments, the indicator added by a particular user is related to a electronic commerce listing associated with that particular user. The indicator is displayed within the content and associated with the electronic commerce listing maintained in, for example, a network-based marketplace or other electronic commerce site at 516.

In particular implementations, the user can create the electronic commerce listing while viewing the content presented by the content provider. For example, after given an opportunity to add an indicator to the content at 514, the user may create the electronic commerce listing to be associated with the indicator. This listing creation can be accomplished, for example, in a separate display window that accesses a system that manages the electronic commerce listings. Thus, the user can create a new electronic commerce listing without navigating away from the site displaying the content presented by the content provider.

In some embodiments, multiple electronic commerce listings associated with multiple users) are associated with the content. In these embodiments, the visual appearance of the indicator may change depending on the number of electronic commerce listings associated with the content. For example, the indicator may display a number corresponding to the number of electronic commerce listings associated with the content. Alternatively, the indicator may change in size, shape, color or other characteristic depending on the number of electronic commerce listings associated with the content.

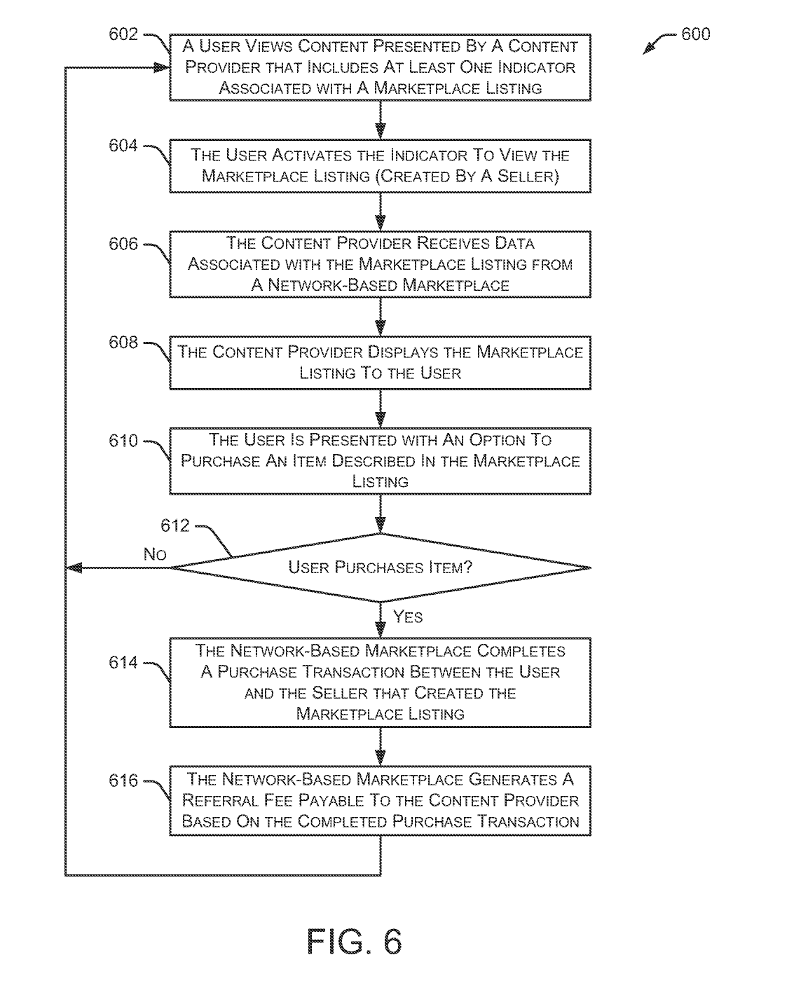

FIG. 6 is a flow diagram of a method 600, in accordance with an embodiment, of completing a transaction with a network-based marketplace initiated by a user accessing content presented by a content provider. In a particular embodiment, at least a portion of method 600 is implemented by a processor or computing system, such as one or more of the processors and computing systems discussed herein. Initially, a user views content presented by a content provider that includes at least one indicator associated with a marketplace listing at 602. While viewing the content, the user activates the indicator to see the marketplace listing associated with the indicator at 604. In particular embodiments, the user activates the indicator by clicking or touching an area proximate the indicator. In other embodiments, the user activates the indicator by positioning a pointer over the indicator for a predetermined time period. In one example, the marketplace listing is created by a different user than the user viewing the content, such as a seller who sells items through the network-based marketplace.

After the user activates the indicator, the content provider receives data associated with the marketplace listing (i.e., the marketplace listing associated with the activated indicator) from the network-based marketplace at 606. The content provider then displays the marketplace listing to the user at 608. In some embodiments, the marketplace listing is displayed in a window (or other display mechanism) that is separate from the window displaying the content. The user is presented with an option to purchase an item described in the marketplace listing at 610. Additionally, the user may be presented with an option to obtain more details about the item associated with the marketplace listing.

If the user chooses not to purchase the item described in the marketplace listing at 612, the user can continue viewing the content presented by the content provider at 602. If the user chooses to purchase the item described in the marketplace listing at 612, the network-based marketplace completes a purchase transaction between the user and a seller that created the marketplace listing at 614. After completing the purchase transaction, the network-based marketplace generates a referral fee payable to the content provider at 616. As discussed herein, the referral fee is paid as compensation to content providers for displaying indicators within the content that cause a user (e.g., a viewer of the content) to initiate a purchase transaction based on the marketplace listing associated with a displayed indicator. After completing the purchase transaction, the user can continue viewing the content presented by the content provider at 602.

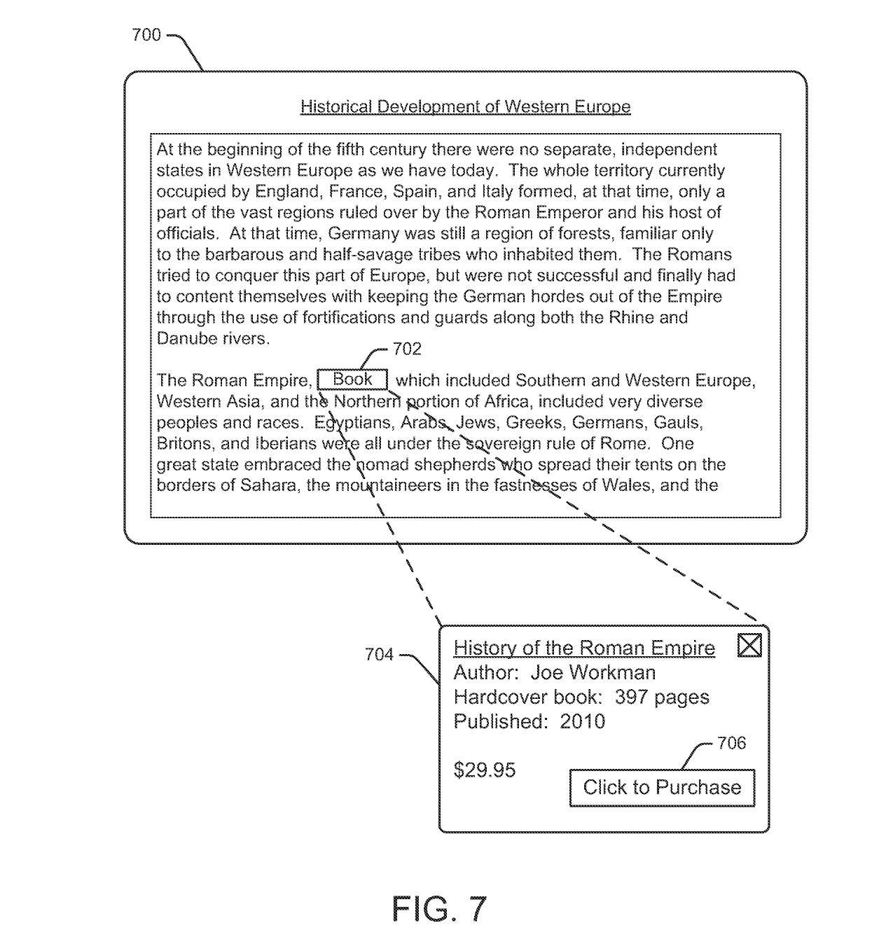

FIG. 7 depicts, in accordance with an embodiment, a portion of a user interface 700 displaying content and an indicator associated with an electronic commerce listing. In this example, user interface 700 is generated by a content provider and is presenting content describing the historical development of Western Europe. An indicator 702 has been added to the content, for example, by a user having an associated item available for purchase through a network-based marketplace. In this example, indicator 702 notifies viewers of the content that the indicator is associated with a book. Although indicator 702 identifies the associated item as a “book”, alternate embodiments of indicator 702 indicate that an item is available without specifying the type of item. Additionally, other embodiments of indicator 702 may include a hyperlink, a highlighted word or phrase, a symbol or any other visual indicator that identifies the association of an item with the content.

The viewer of the content in user interface 700 may activate indicator 702 to learn more about the book. In some embodiments, the viewer activates indicator 702 by clicking in an area proximate indicator 702 (e.g., clicking a mouse button white an associated pointer is positioned proximate indicator 702). In other embodiments, the viewer may activate indicator 702 by positioning a pointer in an area proximate indicator without clicking a mouse button or other device button. In the example of FIG. 7, activation of indicator 702 causes the display of an additional display window 704 that includes information about the book. Display window 704 also includes a “Click to Purchase” button 706 that allows a viewer to purchase the book. In some embodiments, when a viewer activates “Click to Purchase” button 706, a purchase transaction display window (not shown) is presented that allows the viewer to enter purchase information and shipping information (if necessary) to complete a purchase transaction. This allows the viewer to complete the purchase transaction without leaving the site presenting the content or otherwise navigating to another site associated with the electronic commerce listing.

In some embodiments of FIG. 7, indicator 702 is shown to all viewers of the content. However, the additional information shown in display window 704 is presented upon request by the viewer (e.g., in response to the viewer activating indicator 702). Thus, viewers who are not interested in the information associated with indicator 702 (and do not activate indicator 702) are not presented with display window 704.

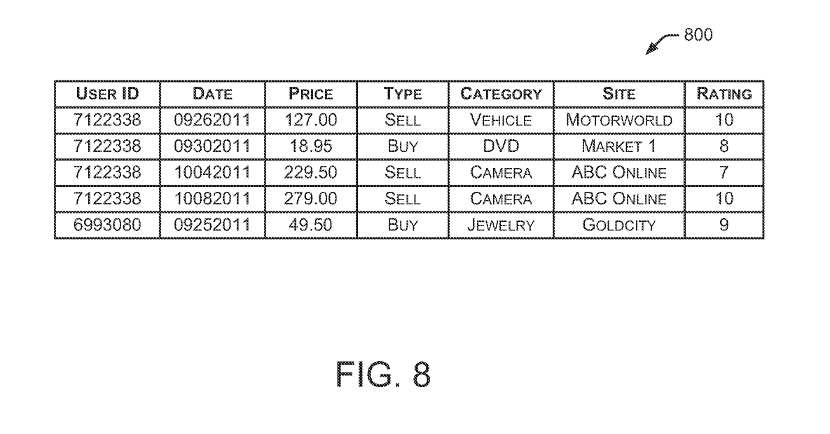

FIG. 8 depicts, in accordance with an embodiment, a table 800 containing user data associated with a user's electronic commerce transactions. Table 800 includes various types of data associated with a user, such as a user identifier (user ID), a transaction date, a transaction price, and a type of transaction (e.g., identifying whether the user was acting as a buyer or a seller in the transaction). Table 800 also includes a category (e.g., the type of item involved in the transaction, the site (e.g., electronic commerce site) handling the transaction (or maintaining the electronic commerce listing), and a rating or other user feedback provided by another participant in the transaction. For example, a buyer may provide user feedback for a user who is acting as a seller in a particular transaction. Similarly, a seller may provide user feedback for a user who is acting as a buyer in a particular transaction.

In other embodiments, table 800 also contains user data including an account login name, account login password, user participation in product reviews, user interests, and information accessed from other services or web sites for which the user has granted access permission. In some embodiments, the user data contained in table 800 also includes URLs or other links to information about the user. In particular embodiments, the user defines what types of data are provided to different individuals or entities.

The user data is useful, for example, in providing product or service recommendations to the user based on previous purchases/sales and other information known about the user. Additionally, the user data can be made available to a particular web site by the user to simplify a registration or transaction check-out procedure (e.g., by pre-filling certain registration or transaction form fields).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by or to control the operation of, data processing apparatus, e.g., a programmable processor, a computer, or multiple computers.

A computer program can be written in any form of programming language, including compiled or interpreted languages, and it can be deployed in any form, including as a stand-atone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g. a FPGA an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

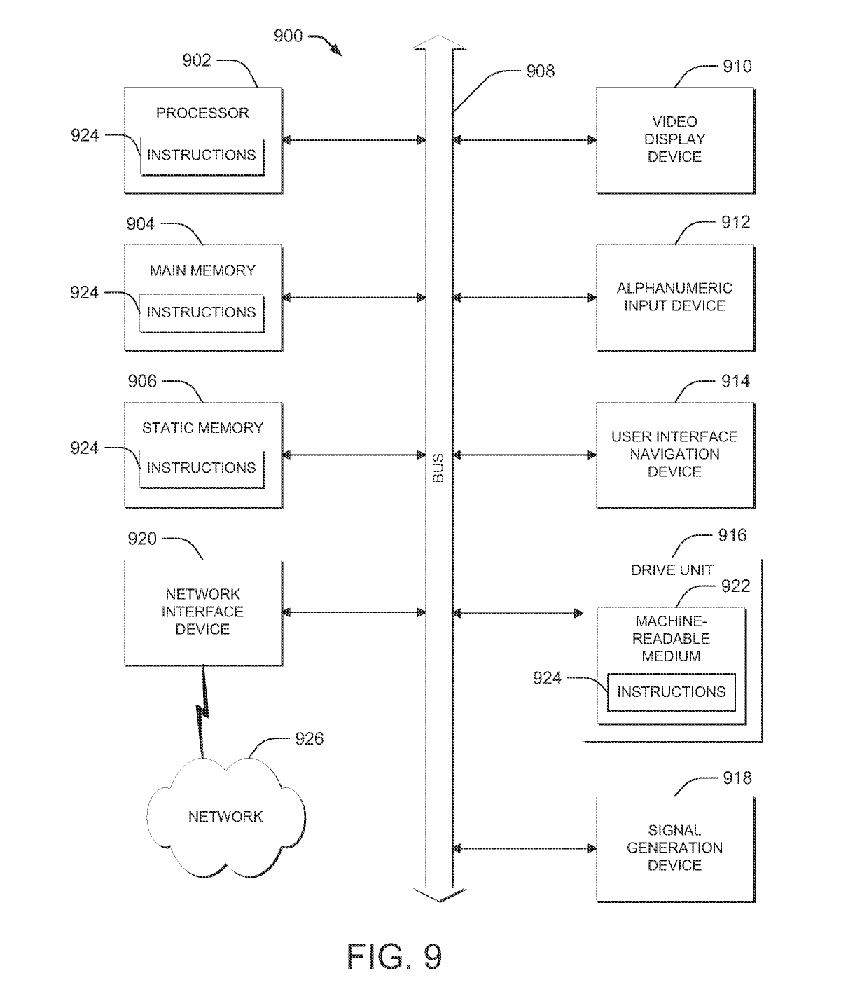

FIG. 9 is a block diagram of machine in the example form of a computer system 900 within which instructions, for causing the machine to perform any one or more of the methodologies discussed herein, may be executed. In alternative embodiments, the machine operates as a standalone device or may be connected networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 900 includes a processor 902 (e.g., a central processing unit (CPU), a graphics processing unit (GPU) or both), a main memory 904, and a static memory 906, which communicate with each other via a bus 908. Computer system 900 may further include a video display device 910 (e.g., a liquid crystal display (LCD) or a cathode ray tube (CRT)). Computer system 900 also includes an alphanumeric input device 912 (e.g., a keyboard), a user interface (124) navigation device 914 (e.g., a mouse), a disk drive unit 916, a signal generation device 918 (e.g., a speaker) and a network interface device 920.

Disk drive unit 916 includes a machine-readable medium 922 on which is stored one or more sets of instructions and data structures (e.g., software) 924 embodying or utilized by any one or more of the methodologies or functions described herein. Instructions 924 may also reside, completely or at least partially, within main memory 904, within static memory 906, and/or within processor 902 during execution thereof by computer system 900, main memory 904 and processor 902 also constituting machine-readable media.

While machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 924 may further be transmitted or received over a communications network 926 using a transmission medium. Instructions 924 may be transmitted using network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
presenting content to a user, the content being presented by a content provider;
receiving a request from the user to associate a marketplace listing of the user with the content;
determining an approval of the request to associate the marketplace listing with the content;
displaying, using one or more processors, an indicator within the content responsive to approval of the request; and
associating the indicator with the marketplace listing responsive to approval of the request.

2. The method of claim 1, wherein determining an approval of the request includes the content provider determining that the marketplace listing is related to the content.

3. The method of claim 1, wherein determining an approval of the request includes the content provider identifying another marketplace listing associated with the content.

4. The method of claim 1, wherein the indicator is a visual indicator contained within the displayed content that identifies an item offered for sale by the user.

5. The method of claim 1, wherein the marketplace listing identifies an item offered by the user in a network-based marketplace.

6. The method of claim 5, wherein the content provider and the network-based marketplace are different entities.

7. The method of claim 1, further comprising displaying marketplace listing details responsive to activation of the indicator by a second user.

8. The method of claim 7, wherein displaying the marketplace listing details includes presenting an offer to the second user to purchase an item associated with the marketplace listing.

9. The method of claim 8, further comprising:
determining that the second user purchased the item; and
generating a referral fee for the content provider responsive to the second user purchasing the item.

10. The method of claim 1, further comprising receiving a second request from a second user to associate a second marketplace listing with the content, the second marketplace listing identifying a second item offered by the second user in the network-based marketplace.

11. The method of claim 10, further comprising determining an approval of the second request to associate the second marketplace listing with the content.

12. The method of claim 11, further comprising changing an appearance associated with the indicator responsive to approval of the second request.

13-16. (canceled)

17. A non-transitory machine-readable storage medium comprising instructions that, when executed by one or more processors of a machine, cause the machine to perform operations comprising:
presenting content to a user, the content presented by a content provider;
receiving a request from the user to associate an electronic commerce listing of the user with the content;
determining an approval of the request to associate the electronic commerce listing with the content;
displaying an indicator within the content responsive to approval of the request; and
associating the indicator with the electronic commerce listing responsive to approval of the request.

18. The non-transitory machine-readable storage medium of claim 17, wherein the indicator is a visual indicator contained within the displayed content that identifies an item offered for sale by the user.

19. The non-transitory machine-readable storage medium of claim 17, wherein the machine further performs operations comprising displaying electronic commerce listing details responsive to activation of the indicator by a second user.

20. The non-transitory machine-readable storage medium of claim 19, wherein displaying electronic commerce listing details includes presenting an offer to the second user to purchase an item associated with the electronic commerce listing.
